(19) United States
(12) Patent Application Publication
(10) Pub. No.: US 2015/0036915 A1
(43) Pub. Date: Feb. 5, 2015

(54) Inspection Method

(71) Applicant: HSEB Dresden GmbH, Dresden (DE)

(72) Inventors: Arman Siahkali, Dresden (DE); Bernd Srocka, Berlin (DE); Hagen Raue, Goeda (DE)

(21) Appl. No.: 14/379,223

(22) PCT Filed: Jan. 25, 2013
(86) PCT No.: PCT/EP2013/051410

§ 371 Date: Aug. 15, 2014

(30) Foreign Application Priority Data
Feb. 16, 2012 (DE) 10 2012 101 242.3

(51) Int. Cl. G06T 7/00

(52) U.S. Cl. CPC G06T 7/001
USPC 382/149

(57) ABSTRACT

The invention relates to a method for the inspection of flat objects, in particular wafers (10, 12, 14, 16, 18, 20, 24, 26, 28, 30), comprising the following steps: recording one digital image of the object surface of several homogeneous objects of a series in each case, wherein each digital image consists of a multiplicity of pixels having an intensity value assigned to the said pixel; and detecting defects on the respective object surface by comparing the recorded image with a reference image; wherein the images of the objects of the whole series are recorded before the comparison with the reference image, and the reference image is generated from several or all images of the series, e.g. by averaging (median) the images of the series.

### TECHNICAL FIELD

The invention relates to a Method for Inspection of flat objects, in particular wafers, comprising the steps of:
(a) taking a digital image of the object surface of several objects of the same kind of a series, wherein each digital image consists of a plurality of image points with an intensity value relating to each image point; and
(b) detecting defects on the respective object surface by comparing the taken image with a reference image;
(c) wherein the images of the objects of the entire series are taken before the comparison with the reference image, and
(d) the reference image is generated from several or all images of the series.

In different branches of the industry flat products are inspected for defects with imaging methods. In semiconductor- and solar cell industry these products are, amongst others, wafers. Wafers are discs of semiconductor-, glass-, sheet- or ceramic materials. The wafers are inspected entirely or at least with large portions thereof. Such an inspection is called Macro-inspection. The lateral resolution required for the detection of the interesting defects increases with developments of the general production technique. Typically, resolutions of 30 microns or less in macro-inspection are required for new technologies. At the same time, devices having a high throughput of wafers for inspection are desirable.

Similar objects must be solved in different branches of the industry. In flat panel industry the displays must be inspected for defects in the production. Partly, imaging methods are used for the detection of defects imaging the entire display. When inspecting printed circuit boards in the electronic industry defects are detected with optical methods on series of specimen.

All such applications have in common that there is a need for quick inspection of a high number of objects which are normally of the same kind. Such objects are printed circuit boards, wafers, solar cells, displays and the like. They also have in common that sensors are used for the generation of large images of the objects. The images can be generated with optical imaging systems as well as with point-wise operating sensors depending on the kind of the detectable defects. Optical imaging systems are, for example line and array cameras. Point-wise operating sensors are, for example, detectors for the measurement of the reflection of optical rays, microwaves or acoustic waves. Magnetic sensors may be used also.

### PRIOR ART

Normally, a plurality of wafers or other objects of the same kind are inspected. Known methods use a wafer as a reference object which is for this case as good as possible with preferably no defects. The defect-free wafer provides the “golden image” as a reference. It is, however, also possible to generate the reference image in a different way, such as, for example, with mathematical methods by using repeating structures on a wafer or by using several wafers.

WO 00/04488 (Rudolph) discloses a method for the generation of a reference image by optical inspecting a plurality of known, good wafers. Unknown wafers are then inspected using a model which uses this reference image.

U.S. Pat. No. 4,644,172 (Sandland) discloses an inspection method where a reference image is manually selected and stored during a training. In pre-selected geometries the inspection is carried out and compared to the stored reference image. Average values and standard deviations are formed.

U.S. Pat. No. 7,012,684 B1 (Hunter) describes an inspection device where the individual signature of reflected or scattered images is detected and processed with signatures of different reflected or scattered images to a reference image.

Known methods take an image and compare it to a—however obtained—stored reference image. The generation of the reference image requires much efforts and a manual control, “recipes” are generated which may be used, tor example, to consider information about the position of dies on the wafer. The comparison of alt images of a charge with objects of the same kind is always made with the same reference image due to these required efforts.

### DISCLOSURE OF THE INVENTION

It is an object of the invention to improve the quality of the inspection method and to automatize the generation of a reference image. According to an aspect of the invention this object is achieved in that
(i) the image points of the images used for generating the reference image are mathematically separated into several image portions and the intensity value of the image point are at first allocated to the portions, from which it is derived;
(ii) a moving average of the intensity values of the image portions with the width of one image point is calculated;
(iii) the images generated with the moving average are superimposed and shifted against each other by a value where a minimum difference of the corresponding intensity values of the image portions is achieved and
(iv) the reference image is generated with such image which is shifted by this value.

According to the invention all images for all objects of a series are taken and the reference image is generated only afterwards. The images of the objects of this series is used. A perfect object (tor example a perfect wafer) is not necessary. With this method the individual object is inspected by comparison with the entire group. Abnormalities shown by all objects of the series are not detected thereby, but only individual defects. The reference image can be generated automatically and without any manual processing.

There are often very small structures on the objects provided for inspection. An example of such structures are dies on wafers with structure diameters in the range of microns or sub-microns. Typically used inspection devices with normal detectors resolve sizes in the range of some microns to some tens of microns, such as, for example, 30 microns. The micro structures are, therefore, not resolved by such systems called macro inspection devices. The interesting defects have much larger diameters in the range of mm in certain applications where the selected resolution is sufficient. The intensities of adjacent image points, however, may have possibly steps due to the unresolved microstructures depending on the position of the unresolved microstructure in the image. Such an effect is known from everyday life where an image has rough image points (pixels). In reality straight edges are stepped and smooth transitions have a rough stair-shaped structure. The correct positioning of the images is, therefore, difficult or only possible with insufficient accuracy.

When the objects are positioned for imaging this is effected with a positioning inaccuracy which is larger than the structures present on the object with normal conditions. The inaccuracy of the positioning will, therefore, cause an error when generating the reference image with a common assembly if such structures are not resolved.

According to the invention the object position is, therefore, taken into account by the characterizing features of claim 1.

The moving average can be calculated by adding up the intensity values for each point of the image portion of the image portions within the area of an original image point and allocated to the central point of the image portion. In other words: the correct positioning of the image is effected by mathematical oversampling. All images can be superimposed very accurately in such a way that the unresolved structures lay in the same position. In such a way the accuracy for generating the reference image can be increased.

In a preferred modification of the invention the series is a sub-group of a larger series of objects and each sub-group generates its own reference image. Then the reference image is very close to the images of objects which were generated in the same production and method process in the same time frame. As the reference image is automatically generated, i.e. by mere calculating the amount of reference images which are generated will not matter.

In a further modification the reference image generated for a group can be stored and compared to preceding or following reference images. A principal tendency can be obtained from such a comparison for the entire production cycle of the objects. It can be checked, for example, if entire sub-groups or charges deviate from the overall image of the objects by detecting if and/or how much the reference images vary one from another. In the production of semiconductors, for example, lithographic defects of entire charges or drifting process parameters (layer thicknesses, for example) can be recognized automatically.

The reference image can be generated by averaging the images of a series. However, a median or any other suitable averaging method may be used. Furthermore, any other common preprocessing steps, such as De-Bayering, smoothing, differentiating can be applied depending on the precise detection purpose. The average of all intensity values is calculated at the same point for different objects for calculating the average value of the images at all image points. Accordingly, always the same image point of an image is used for averaging when taking images of identically positioned objects.

Preferably, the object position is taken into account when taking the digital image for generating the reference image. The object position may then slightly vary from object to object. Thereby, even with good positioning of the objects the quality of the reference image can be improved.

Further modifications of the invention are subject matter of the subclaims. An embodiment is described below in greater detail with reference to the accompanying drawings.

### BRIEF DESCRIPTION OF THE DRAWINGS

FIG. 1 shows 10 wafer images 1a to 1j with different defects and two regular, repeating structures.

FIG. 2 shows a reference image generated from the wafer images of FIG. 1.

FIG. 3 shows the resulting images of the comparison of the wafer images with the reference image

FIG. 4 shows a sensor section with a contrasting edge.

FIG. 5 shows an image taken with the sensor of FIG. 4 with measured intensity values.

FIG. 6 illustrates a first step for mathematical oversampling with 5×5 times partitions and where the raw sensor values are copied.

FIG. 7 illustratres a second step with mathematical oversampling and the result of the 5×5 moving averaging of the raw sensor values.

### DESCRIPTION OF THE EMBODIMENT

The embodiments are described using schematic representations of a wafer. It is understood, however, that real images will have a different appearance where the invention can be, however, applied in the same manner.

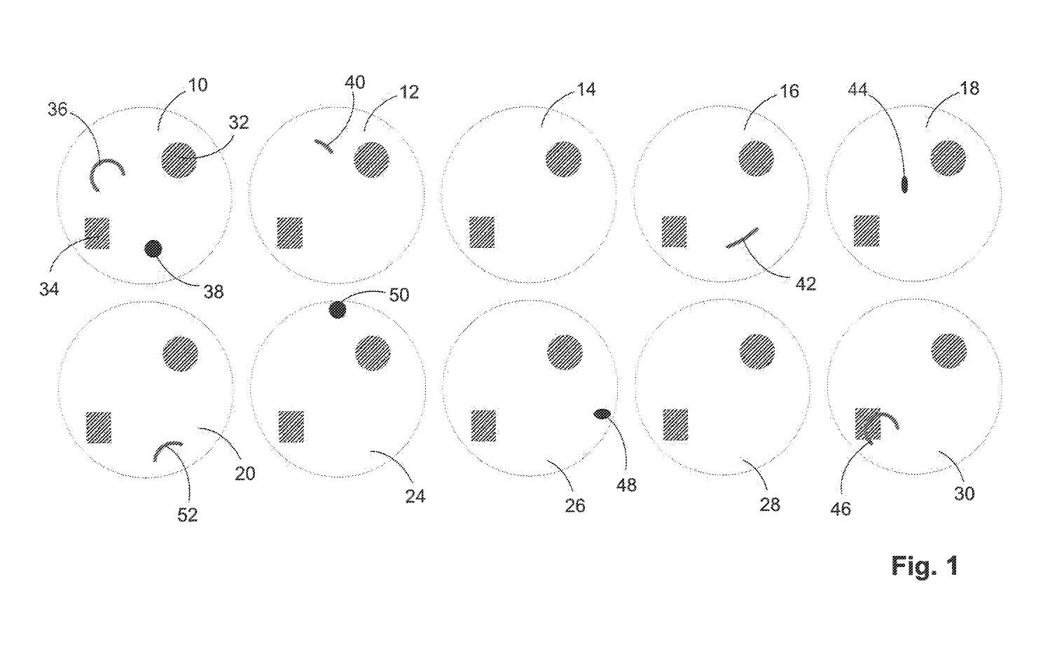

FIG. 1 is a top view of the surfaces of ten different wafers which are generally designated with numerals 10, 12, 34, 16, 18, 20, 22, 24, 26, 28 and 30. The wafers 10, 12, 14, 16, 18, 20, 22, 24, 26, 28 and 30 have defects. Wafer 10, tor example, has four defects designated with numerals 32, 34, 36 and 38. It can be easily recognized that the other wafers 12, 14, 16, 18, 20, 22, 24, 26, 28 and 30 also have defects corresponding to the defects 32 and 34. The defects 36 and 38 of the wafer 10 have in the present embodiment no corresponding defects on the remaining wafers 12, 14, 16, 18, 20, 22, 24, 26, 28 and 30, In a similar way a defect 40 is present on the surface of the wafer 12 which does not correspond to any of the defects on the other wafers. The other wafers 16, 18, 20, 22, 24, 26, 28 and 30 also have individual defects 42, 44, 46, 48, 50 and 52.

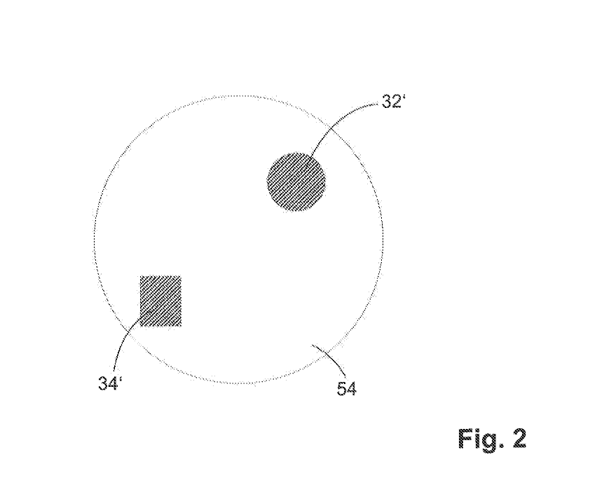

A median is calculated for each image point on the surface of the wafer 10 and the corresponding image point on the surface of the other wafers 12, 14, 36, 18, 20, 22, 24, 26, 28 and 30. An average is calculated in a different, alternative embodiment which is not shown here. The image assembled of the median values is shown in FIG. 2. The image of a wafer surface 54 can be recognized with two defects 32′ and 34′. They exactly correspond to the defects 32 and 34 which were present on all original wafers of the group. They do not vanish when a median is calculated. Defects 36, 38, 40, 42, 44. 46, 48, 50 and 52, however, which occur only on one of the wafers, vanish with the calculation of the median and cannot be recognized anymore in the assembled image 54.

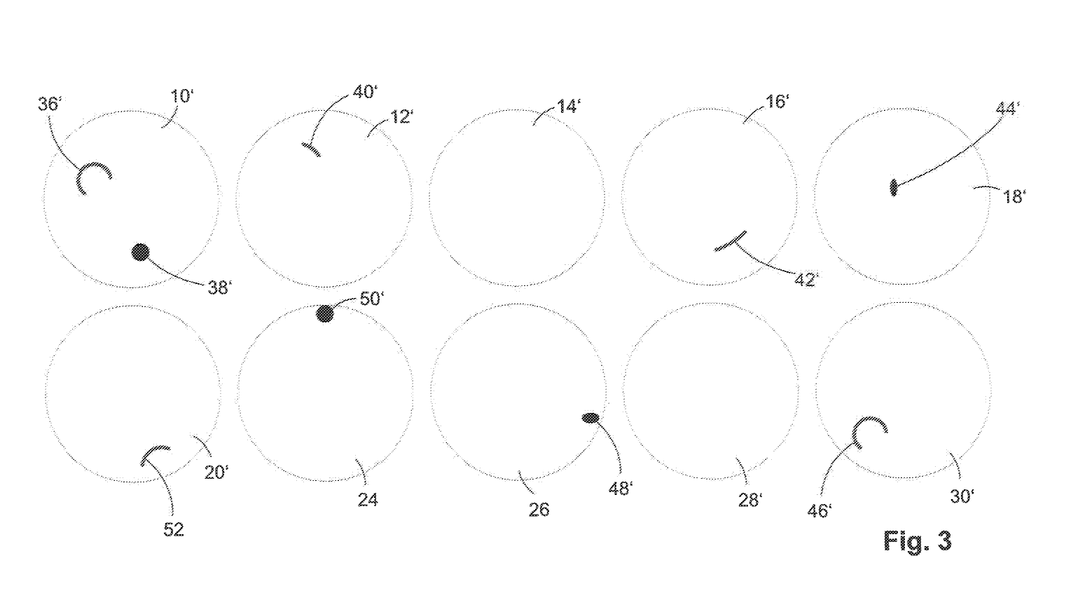

FIG. 3 shows the difference of the values on the image points in FIG. 1 and the values of the reference image 54 for each of the wafers 10, 12, 14, 16, 18, 20, 22, 24, 26, 28 and 30. Defects 32 and 34 occurring in all wafers are compensated and only individual defects 36′, 38′, 40′, 42′, 44′, 46′, 48′, 50′ and 52′ remain recognizable. In such a way individual defects can be distinguished from defects and effects which occur for all wafers in a group and can be easily recognized and corrected.

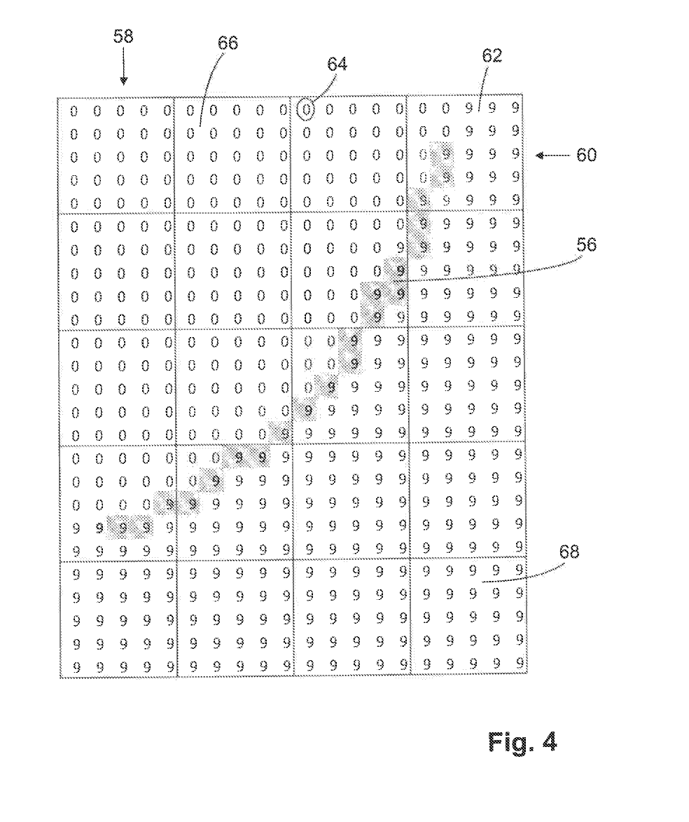

The oversampling is shown in an example with a sharp edge 56 running through the image. FIG. 4 shows the scene imaged with a resolution corresponding to a fifth of the sensor resolution (squares in the image). 4×5 image points 62 can be seen in 4 columns 58 and 5 lines 60. An intensity distribution is shown in the form of 5×5 intensity values 64. In the present embodiment the image points 66 in the upper left range of the section have the intensity value 0. The intensity values on the image points 68 in the lower right region of the section have the intensity value 9. A sharp edge 56 extends therebetween. The assumed curved edge 56 is highlighted in FIG. 4.

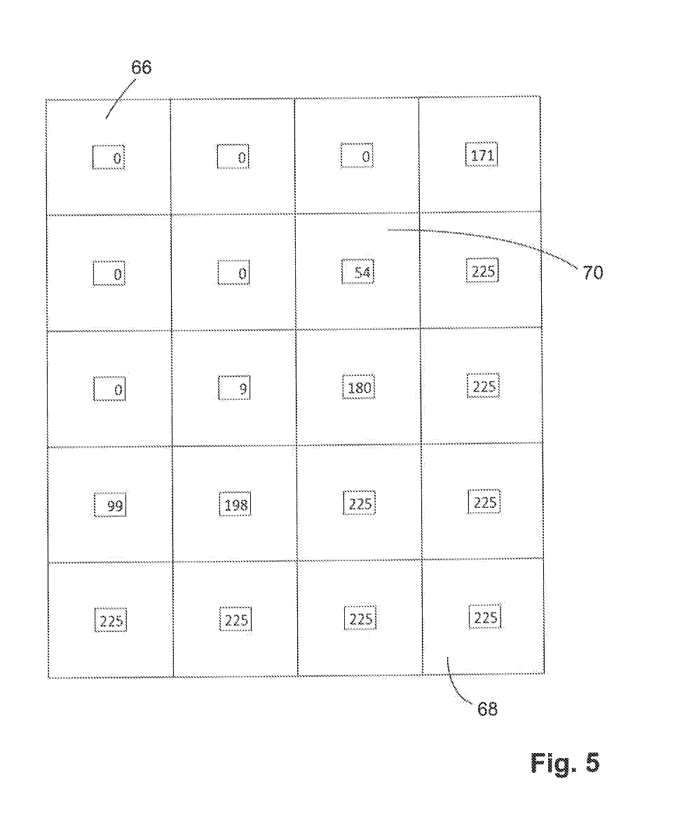

FIG. 5 shows which raw data are generated by the sensor when an image is taken corresponding to its resolution. It can be seen, that the sensor measures the value 0 with the image points 66 in the upper left range where all intensity values are 0. With the image points in the lower right range, where all intensity values are 9 the sensor measures the value 225 corresponding to the sum of all intensity values on the 5×5 cells. In the range therebetween where there is the edge 56 the measuring values are inbetween. Image point 70 of the sensor, for example, will have the value 54 corresponding to 6 cells out of 25 with the intensity value 9 and 19 cells having the intensity value 0.

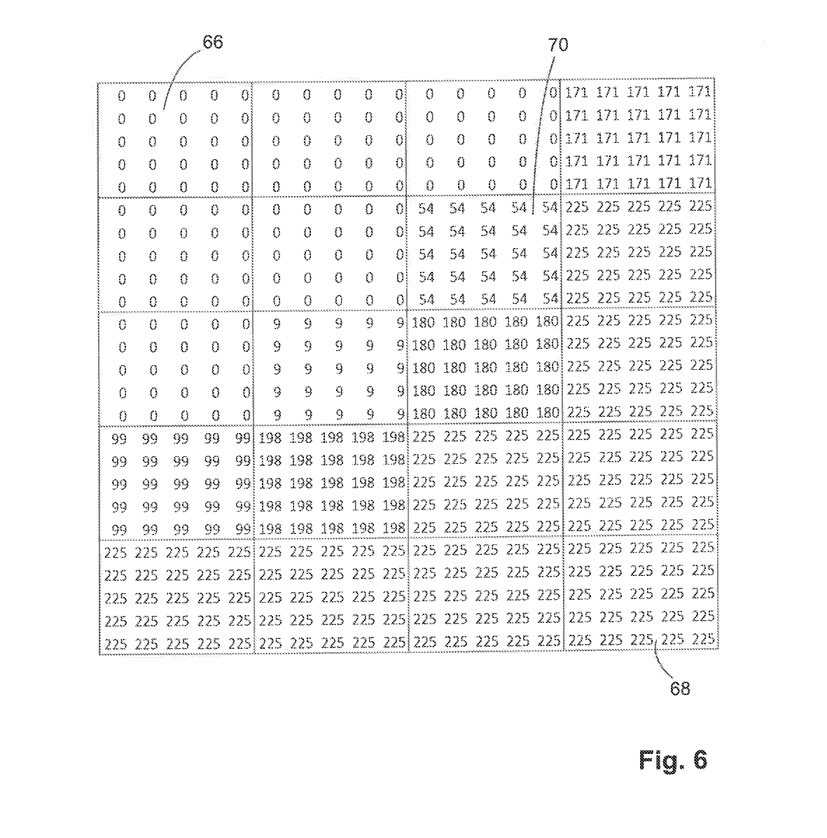

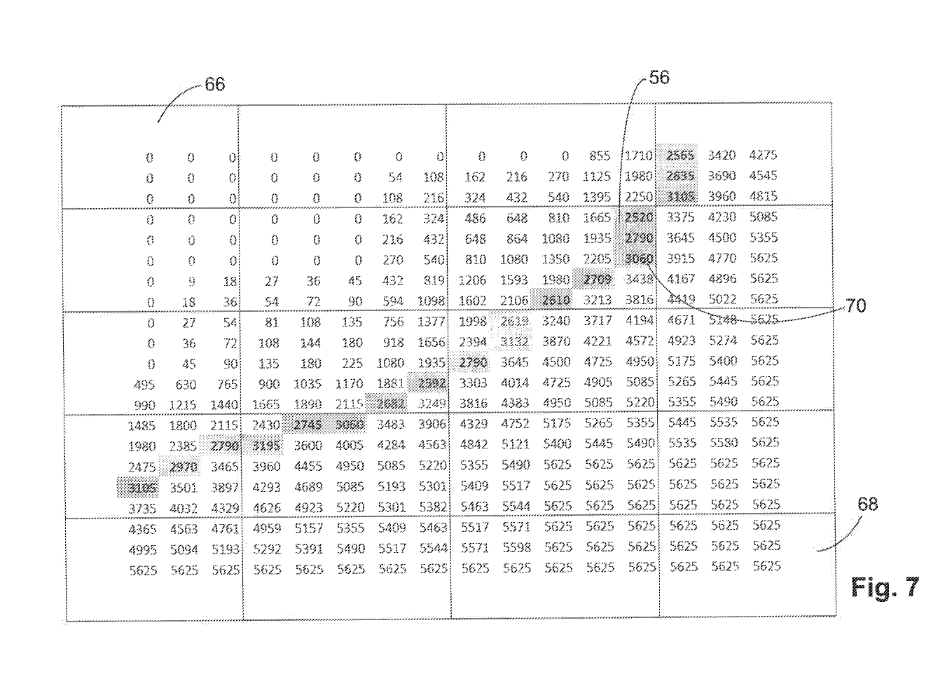

The edge present in reality can be resolved by mathematical oversampling during evaluation. FIGS. 6 and 7 show the oversampling. As an example the oversampling is effected with 5×5. At first the sensor values of FIG. 5 are copied to 5×5 cells which are sections of each sensor pixel. This can be seen in FIG. 6. It can be seen, that each of the 25 cells of the image point 70 in FIG. 6 has the value 54, Accordingly each of the 25 cells of the image point 66 has the value 0 and each of the 25 cells of the image point 68 has the value 225.

Then, a new average value is attributed to each cell by moving average over the surrounding of the 5×5 cells. This is shown in FIG. 7, The averaging has two effects: The contrast edge extension is smoothed and the position of the edge is better, i.e. with better fitting to the original position shown in FIG. 4. It can be seen, that values in the cells of image point 66 where the adjacent image points have the value 0 still have the value 0 whereas the values in cells in image point 68 where the adjacent values are maximum are also maximum. There are more intermediate values therebetween, than it was the case with the measurement. The values in image point 70, for example, are larger in the lower right range than in the upper left range, because the adjacent measuring values are larger or smaller, respectively.

As the value range in the example was selected from 0 to 9 the oversampled image generated in the above described way has a value range from 0 to 5625, The line of the edge 56 can, therefore, be found at the value 5625/2=2812,5. The cell values which are nearest to this value are highlighted in FIG. 7. It can be seen that the curvature of the edge 56 represents the original curvature much better than the raw data of the sensor can do.

With such a method it is possible to better localize structures than with raw sensor data. This can be used, for example, when the position of the images are adjusted with respect to each other (registering) and for the detection of defects and deviations. In particular, known algorithms such as edge inspection, feature recognition, pattern matcher can be used better and more accurately for adjustment when using the images processed according to the above described method.

The required moving average calculation (step 2—FIG. 7) can be carried out with any suitable known averaging method. A median can be used also.

The above description was illustrated using a sensor section with the size of 4 columns and 5 lines corresponding to 20 image points. It is understood, however, that real sensors and the images generated thereby are much larger and have sometimes diameters of up to several millions of pixels. Also, different values and curvatures etc. can apply, In particular, the method is also applicable with a line camera, several small sensors and with images assembled from several of such images.

1. A method for the inspection of a series of wafers or other flat objects, said wafers or other flat objects having an object surface, comprising the steps of:
(a) taking a digital image of said object surface of several objects of the same kind of said series, wherein each digital image consists of a plurality of image points with an intensity value relating to each image point; and
(b) providing a reference image schemed from several or all of said images of said series;
(c) detecting defects on said object surface by comparing said image to said reference image;
(d) wherein said images of said surfaces of said entire series are taken before the comparison with said reference image; and
characterized in that
(i) said image comprises image points with intensity values which are used for generating said reference image, wherein said image points are mathematically separated into several image portions and said intensity values of said image points are at first attributed to said image portions, from which they were derived;
(ii) a moving average of said intensity values of said image portions with the width of one of said image points in calculated;
(iii) images are generated with said moving average by superimposing and shifting said images against each other by a value where a minimum difference of the corresponding intensity values of said image portions is achieved; and
(iv) said reference image is generated with said image which is shifted by this value.

2. The method of claim 1, and wherein said series is a sub-group of a larger series of objects and each sub-group generates its own reference image.

3. The method of claim 1, and wherein said reference image is generated by averaging the said images of a one series.

4. The method of claim 1, and wherein said objects have a position which is taken into account when taking said digital image for generating said reference image.

5. (canceled)

6. The method of claim 1, and wherein said moving average is calculated by adding up said intensity values for each of said points of said image portion within the area of an original image point and allocated to a central point of said image portion.
